(19) United States
(12) Patent Application Publication
(10) Pub. No.: US 2007/0210545 A1
(43) Pub. Date: Sep. 13, 2007

(54) Material transport cart

(75) Inventor: Maynard F. Klotz, Naperville, IL (US)

Correspondence Address: SEYFARTH SHAW LLP, 131 S. DEARBORN ST., SUITE2400, CHICAGO, IL, 60603-5803, US

(73) Assignee: Welding Company of America

(21) Appl. No.: 11/595,622

(22) Filed: Nov. 10, 2006

(51) Int. Cl. B62B 3/00

(52) U.S. Cl. 280/47.35

(57) ABSTRACT

A cart for transporting material has wheels located intermediate to end wheels, the intermediate wheels extending downwardly a greater distance than the end wheels so that the cart may tilt and may be turned around the intermediate wheels. The wheels may be mounted on flanges depending from a frame of the cart, the flanges serving to protect the wheels and serving to support the cart in the event of a wheel failure. The cart may have a pair of wheels located intermediate to the end wheels so that traversing uneven terrain is improved and eased, and so that the intermediate wheels serve as backups to each other. The intermediate wheels may be a same or similar size, though mounted lower on the flanges, than the end wheels. The intermediate wheels may be larger than the end wheels.

### FIELD OF THE INVENTION

The invention relates to carts or other human-powered wheeled devices for transporting material and, in particular, to such carts having caster-less wheel assemblies.

### BACKGROUND

Many devices are known for transporting materials or items. As an example, what is commonly referred to as a shopping cart is used at a grocery store. The shopping cart includes a pair of rear wheels that are caster-less so that, other than rotating around their centerline and an axle, the wheels remain stationary relative to the cart. In other words, the rear wheels rotate around a horizontal axis, but do not rotate or pivot around a vertical or other non-horizontal axis. In order to turn the grocery cart, a pair of front wheels is provided with caster assemblies that allow the front wheels to rotate and be oriented in a direction other than parallel to the rear wheels.

However, carts having casters are not suitable for transporting heavy loads, such as lumber, building materials, landscaping materials, or gas cylinders. In particular, many casters have ball bearings which may be crushed due to heavy loading or which may distort the races and raceways under heavy pressure. Bearing-less casters have lubricated friction surfaces which must slide against each other. Heavy loads press and expel the lubrication from between the friction surfaces, and the pressure can cause the friction surfaces to bind and/or distort, rendering them useless for turning.

A known device or cart for transporting heavy loads utilizes a pair of caster-less front wheels, a pair of caster-less rear wheels, and a pair of caster-less intermediate wheels. In this arrangement, the lowermost extents of the front and rear wheels can be said to define a plane, and the lowermost extents of the intermediate wheels extend below such plane. Accordingly, such a cart may be tilted so that either the front or rear (or neither) wheels may be in contact with the ground, while the intermediate wheels are generally always in contact with the ground. Hence, such a cart may be referred to as a “tiltable” cart. As all these wheels are caster-less, they do not move relative to the cart other than rotating around their substantially horizontal central axes. This allows the cart to be turned by balancing the cart on only the intermediate or central wheels and rotating the cart around these central wheels.

There are two basic configurations for having the intermediate wheels extend beyond the plane of the other wheels. First, the axles of the intermediate wheels may be mounted to the cart at a lower point than the axles for the other wheels. Thus, all the wheels may be of a substantially identical diametral size, and the intermediate wheels are positioned to allow the cart to tilt. In the second configuration, the axles for all the wheels are generally mounted at the same height of the cart, but the intermediate wheels are larger than the other wheels so that the intermediate wheels extend below the other wheels, again providing the tilting feature to the cart.

A number of problems are encountered with these tiltable carts. The wheels are secured with the cart by mounting brackets principally comprising a pair of V-shaped tabs extending downward from the bottom of a base of the cart with the axle mounted thereon and the wheel therebetween. During operation, the weight is borne by the central portion of the cart to a greater degree than the sides, imposing a greater burden on the central or intermediate wheels. Accordingly, should a wheel break during service under load, it is typically one of the central wheels which tends to fail. Then cart will then collapse so that a front wheel and a rear wheel on one side support the cart, while the other side is supported be either the remaining central wheel solely, or by the remaining central wheel and one of the other rear or front wheels. Because the remaining central wheel extends below the plane of the other wheels, the cart will list to one side, and movement of the cart will be in a circular path. As such a path cannot be controlled, such condition requires the material on the cart be unloaded onto another cart for moving to the proper location or destination.

Another problem inherent in these tiltable carts is encountered when going over, up, or down incongruities in the surface supporting the cart. For instance, an industrial area often has a poured concrete floor. The floor, like a sidewalk, will have expansion/contraction seams or grooves provided between sections of the floor. During pouring itself, or due to settling of the floor resulting in a crack at the seam, the floor sections may be uneven. With the single pair of central wheels, traversing over the seam from one floor section to a lower floor section often results in a jolt when the central wheels drop down to the lower floor section. The heavy loads then bounce somewhat, which may cause damage to them as well as may damage the wheels themselves. Conversely, going from one floor section to a higher floor section (or merely riding over the seam itself) requires significant additional force from an operator.

The carts are often moved from a floor to a truck, for instance, by forklifts. As should be readily apparent, the weight of the materials often renders the loaded cart difficult, if not dangerous, to push up a ramp into a vehicle. Forklifts may solve this problem, but they rely on inserting forklift tines underneath the base of the cart and between the wheels of each pair. Precise alignment of the forklift tines with the opening between the wheels of each pair, though not difficult, may be time consuming. As a time-savings measure, forklift operators or drivers commonly use the tines to move the cart itself into proper alignment, rather than the other way around. More specifically, forklift tines are movable in a vertical direction, may be tilted forward and backward, and may shift left to right (and vice versa) relative to the forklift itself. A forklift operator may place one tine between the wheels, and then move the tines in one direction to shift the cart into a desired or suitable orientation. In doing so, the surface against which the tine applies force is typically either the wheel or the mounting bracket thereof. Use of the forklift in this manner may easily damage the wheel or the mounting bracket, leading to failure of the bracket or the wheel.

Another problem arises from the use of V-shaped tabs for the mounting brackets, noted above. When one wheel fails, its mounting bracket is often damaged as well so that the collapsing cart causes the tabs to bend and also collapse. This can result in severe listing or tilting of the cart, which may cause the heavy material to fall off the cart. It can also result in the broken mounting bracket to gouge into the floor, making any movement of the cart difficult.

Accordingly, there has been a need for an improved tiltable cart for transporting material, in particular heavy loads of material.

### SUMMARY

In accordance with an aspect, a tiltable cart for transporting material is disclosed having a frame, and a plurality of wheels rotatably mounted to the frame in substantially parallel alignment and having lowermost points, a first pair of the wheels generally positioned at a first end of the cart, a second pair of the wheels positioned generally at a second end of the cart, and third and fourth pairs of the wheels being positioned generally intermediate the first and second pairs of the wheels. The third pair of the wheels is positioned in relative close proximity to the fourth pair of the wheels, the lowermost points of the first and second pairs of the wheels are tangent to a first plane below the frame, and the lowermost points of the third and fourth pairs of wheels are spaced further below the frame than the first plane. A first wheel of each respective pair may be secured on a first side of the frame, and a second wheel of each respective pair may be secured on a second side of the frame opposite the first side of the frame. The wheels of the third and fourth pairs may be larger than the wheels of the first and second pairs.

In this manner, the cart is tiltable so that the first and second pairs of wheels are alternately contactable with an underlying ground surface, which allows the cart to be turned while having caster-less wheels. The third and fourth pairs of wheels allow the tiltable cart to move over uneven pavement surfaces without a jolt or impact from dropping down a level or without a user having to apply significantly greater force to move the cart up a level. The third and fourth pairs of wheels also serve as a backup in the event one of the wheels fails, allowing the cart to be operable even with a broken wheel.

The cart may include a tower structure extending upwardly from the frame. The tower structure may include securement structure for receiving, supporting, or securing material therewith. The tower structure may be adapted for securing gas cylinders with the cart.

The third and fourth pairs of wheels may be mounted lower on the frame than the first and second pairs of wheels. Alternatively or in addition, the third and fourth pairs of wheels may be larger than the first and second pairs of wheels.

In another aspect, a cart for transporting material is disclosed having a frame including flange portions extending downwardly therefrom, and a plurality of wheels rotatably mounted to the flange portions in substantially parallel alignment and having lowermost points, a first pair of the wheels generally positioned at a first end of the cart, a second pair of the wheels positioned generally at a second end of the cart, and at least a third pair of the wheels being positioned generally intermediate the first and second pairs of the wheels, lowermost points of the wheels of the third pair being lower than the lowermost points of the first and second pairs of the wheels, the flange portions extending over sides of the wheels to a position in close proximity to a ground surface. In one form, the third pair of wheels is mounted lower on the frame than the first and second pairs of wheels.

The wheels are mounted between a pair of flange portions. Preferably, first wheels of each respective pair of the wheels are secured on a first flange portion in substantially parallel alignment with each other, and second wheels of each respective pair of the wheels are secured on a second flange portion in substantially parallel alignment with each other. The first wheels are mounted between the first flange portion and a third flange portion, and the second wheels are mounted between the second flange portion and a fourth flange portion. The first wheels are mounted generally at one side of the frame, and the second wheels are mounted generally at a second side of the frame.

In this aspect, the cart may further include a fourth pair of wheels positioned generally intermediate the first and second pairs of the wheels, the fourth pair of the wheels being positioned in relative close proximity to the third pair of the wheels, and the third and fourth pairs of wheels are mounted at approximately the same height on the flange portions.

As such, the flanges serve to protect the wheels from damage, particularly due to use with a forklift. The flanges also serve to reduce the amount of tilting or listing that may occur should a wheel break. That is, the flanges positioned closely to the ground or underlying support surface permit only a short drop by the cart should a wheel break, thereby reducing how much the cart leans or lists due to the wheel failure. Furthermore, the flanges provide support should such wheel failure occur, and the load required to crush the flanges in such an event is relatively high in comparison to the mounting structures of other tiltable carts.

In a further aspect, a cart for transporting material is disclosed having a frame, and a plurality of wheels rotatably mounted to the frame in substantially parallel alignment, a first pair of the wheels generally positioned at a first end of the cart, a second pair of the wheels positioned generally at a second end of the cart, and third and fourth pairs of the wheels being positioned generally intermediate the first and second pairs of the wheels, wherein the third pair of the wheels is positioned in relative close proximity to the fourth pair of the wheels, and the third and fourth pairs of wheels are tangent to a first plane and the first and second pairs are tangent to a second plane, the first plane spaced further below the frame than the second plane. The third and forth pairs of wheels may be mounted lower on the frame than the first and second pairs of wheels. A first wheel of each respective pair may be secured on a first side of the frame, and a second wheel of each respective pair may be secured on a second side of the frame opposite the first side of the frame. The cart may be tiltable so that the first and second pairs of wheels are alternatively contactable with an underlying support surface. The cart may includes a tower structure extending upwardly from the frame, the tower structure including securement structure for receiving, supporting, or securing material therewith. The tower structure may be adapted for securing gas cylinders.

### BRIEF DESCRIPTION OF THE DRAWINGS

FIG. 1 is a perspective view of an embodiment of a material transport cart of the present invention;

FIG. 2 is a side elevational view of the cart of FIG. 1;

FIG. 3 is a bottom plan view of the cart of FIG. 1;

FIG. 4 is a fragmentary perspective view of a bottom side of the cart of FIG. 1; and

FIG. 5 is a side elevational view of a second form of a material transport cart of the present invention.

### DETAILED DESCRIPTION

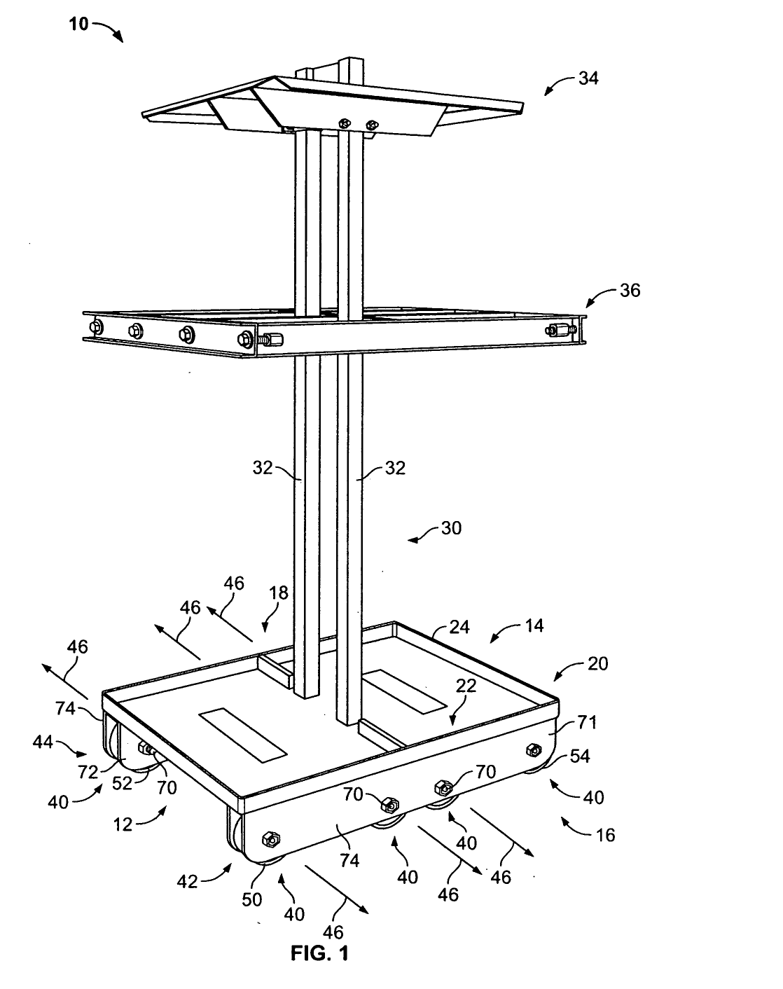

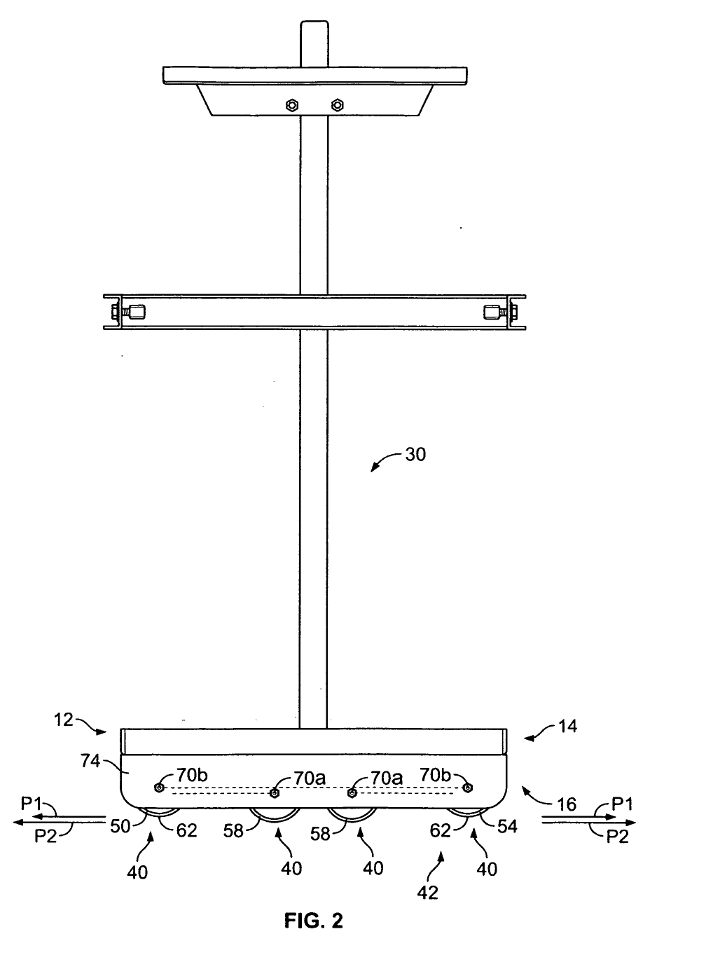

Referring initially to FIGS. 1 and 2, a material transport cart 10 is shown having a front end 12, a rear end 14, and left and right lateral sides 16, 18. It should be noted that usage of the terms front, rear, left, and right, as used herein, is for convenience, and that the cart 10 may be propelled or pushed in a direction so that either the front or rear end is a leading end when moved. The cart 10, as shown, is designed to carry cylinders (not shown) of compressed gas. Towards this end, the cart 10 includes frame in the form of a base 20 including a generally flat support plate 22, and a retention wall 24 around the periphery of the support plate 22. The gas cylinders may be placed on the support plate 22 and within the retention wall 24 to restrict or prevent movement thereof when the cart 10 is loaded and moved. Reinforcing members (not shown) may be mounted to an underside of the support plate 22 for increased strength and support. The cart 10 further includes a superstructure tower or support stanchion 30 extending substantially vertically from the support plate 22. The support stanchion 30 includes a pair of substantially tubular vertical supports 32 which support upper and lower retention braces 34 and 36. In some forms, the retention braces 34, 36 may be adjustable vertically along the vertical supports 32, and the lower retention brace 36 may have side pieces that are releasably secured to allow gas cylinders to be loaded or unloaded therefrom.

In order to permit the cart 10 to be moved, caster-less wheels 40 are provided along the left and right lateral sides 16, 18. More specifically, a left row 42 of wheels 40 is provided on the left side 16 and a right row 44 of wheels 40 is provided on the right side 18. Each wheel 40 has a rotational axis 46, and the wheels 40 are generally aligned so that all the axes 46 of each wheel 40 of either row 42, 44 are generally parallel. Preferably, the wheels 40 of each row 42 are also aligned so that they are co-planar, that is, so that the wheels 40 of each row 42, 44 have a common central plane of rotation perpendicular to the axes 46.

The wheels 40 are referred to herein by their relationship to the front end 12 and rear end 14, as well as to the left and right sides 16, 18. Accordingly, the front end 16 of the cart 10 has a left front wheel 50 (of the left row 42) and a right front wheel 52 (of the right row 44). The rear end 14 has a left rear wheel 54 and a right rear wheel 56.

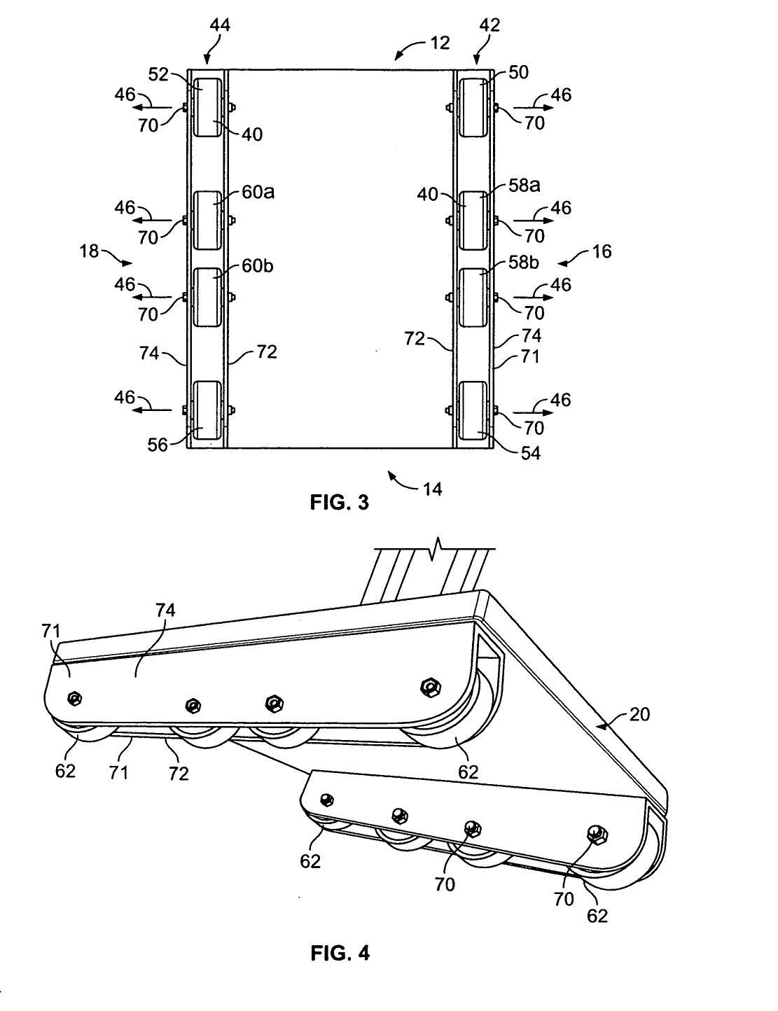

With reference to FIGS. 2 and 3, additional wheels 40 are positioned between the front and rear ends 12, 14. More specifically, the left row 42 includes a pair of left intermediate wheels 58, and the right row 44 includes a pair of right intermediate wheels 60. Each intermediate wheel 58, 60 is positioned closely adjacent to the other intermediate wheel 58, 60 of its respective pair.

The left front and rear wheels 50, 54 and the right front and rear wheels 52, 56 are mounted so that they extend below the cart base 20, and lowermost points 62 on each of these wheels 50, 52, 54, 56 generally define a plane P1. The intermediate wheels 58, 60 also are mounted so that they extend below the cart base 20; however, these wheels 58, 60 extend below the cart base 20 to an extent such that their lowermost points 64 form a plane P2 that is below the plane P1. In other words, the plane P2 of the intermediate wheels 58 is spaced further from the base 20 than is the plane P1 of the front and rear wheels 50, 52, 54, 56.

Thus, the intermediate wheels 58, 60 allow the cart 10 to be tilted and are used to turn the cart 10. As the cart 10 is moved over a bump of an underlying support surface (such as a crack or a concrete expansion seam), the cart 10 may be tilted rearward to allow first intermediate wheels 58a, 60a (FIG. 3) to pass over or beyond the bump either to a higher or lower elevation. Once the first intermediate wheels 58a, 60a pass beyond the bump, the cart 10 may be tilted forward so that first intermediate wheels 58a, 60a, as well as the front left and right wheels 50, 52, are brought into contact with the surface. Movement of the cart 10 may then continue so that second intermediate wheels 58b, 60b (FIG. 3), as well as the rear left and right wheels 54, 56, pass over the bump. In this manner, the cart 10 reduces or substantially eliminates any sharp jolt when going down a bump and the difficulty of pushing a loaded cart up a bump, which are problems associated with other tiltable carts. It should also be noted that, in the event one of the intermediate wheels 58, 60 should fail (i.e., break or be crushed), the remaining intermediate wheels 58, 60 would provide sufficient support for the cart 10 to still be moved without unloading or being carried by a forklift.

The wheels 40 are mounted on axles 70, typically formed by a bolt, secured with mounting flanges 71 that depend from the bottom side of the cart base 20. Each row 42, 44 is provided with an inner and outer flange 72, 74 that generally extend the length of the respective side 16, 18. The axles 70 pass through the wheels 40 and are secured with the inner and outer flanges 72, 74. The inner flanges 72 are positioned apart a distance sufficient to permit forklift tines to be received therebetween for lifting the cart 10, such as for placing the cart 10 on a truck. The flanges 72, 74 extend downwardly to a position close to the lowermost points of the intermediate wheels 58, 60 so that the majority of each wheel 40 is covered on both its inner and outer sides. In this manner, the wheels 40 are protected from the forklift tines, either when a forklift is used to move the cart 10 or to lift the cart 10, as well as from accidental contact to the outside of the wheels 40. A further benefit of the flanges 72, 74 is that, should one or more wheels 40 fail, the cart 10 will only drop to a level where the flanges 72, 74 contact the ground surface. This minimizes the listing of the cart 10 so that material thereon is less likely to fall off and is easier to unload, if necessary. Furthermore, when compared to wheel mounting tabs of known tiltable carts, the flanges 72, 74 provide additional strength to minimize likelihood of failure by the mounting structure. Should a wheel 40 fail, the flanges 72, 74 are less likely to also fail when they, under load, come into contact with the ground surface.

With reference to FIG. 2, one form of the cart 10 is shown having the intermediate wheels 58, 60 extending below the plane P1 formed by the lowermost points of the front and rear wheels 50, 52, 54, 56. As can be seen, axles 70a for the intermediate wheels 58, 60 are mounted on the flanges 72, 74 at a level below that of axles 70b for the front and rear wheels 50, 52, 54, 56. In this form, the intermediate wheels 58, 60 may be substantially of the same size as the front and rear wheels 50, 52, 54, 56.

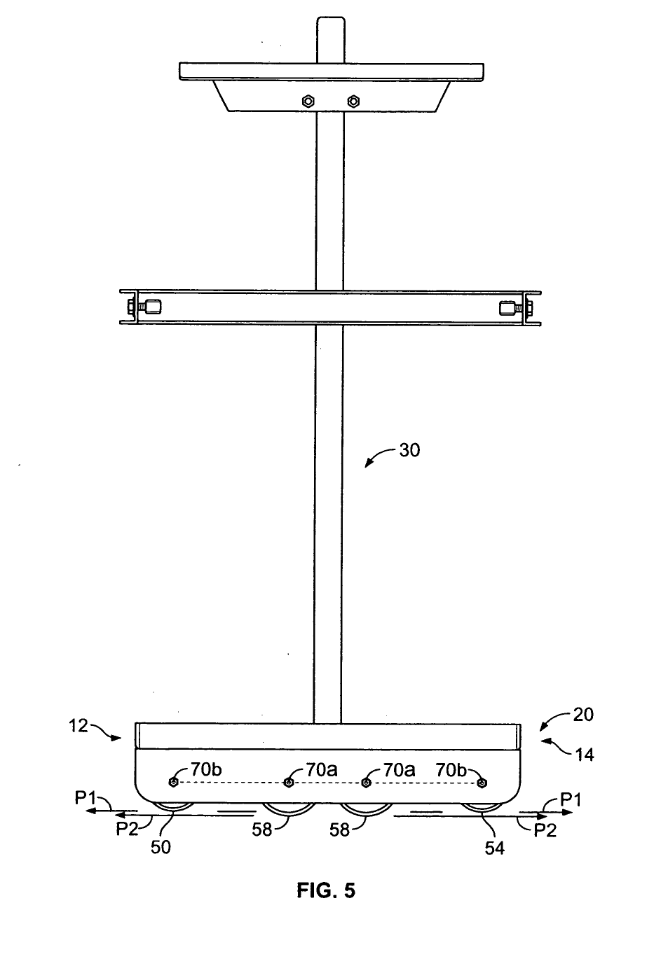

In an alternative form, shown in FIG. 5, the axles 70a for the intermediate wheels 58, 60 may be mounted at generally a same level as the axles 70b for the front and rear wheels 50, 52, 54, 56. In this form, the intermediate wheels 58, 60 have a larger diametral size than the front and rear wheels 50, 52, 54, 56 so that the intermediate wheels 58, 60 extend below the cart base 20 to a greater extent than do the front and rear wheels 50, 52, 54, 56. In this manner, the intermediate wheels 58, 60 extend below the plane P1 formed by the lowermost points of the front and rear wheels 50, 52, 54, 56, allowing the cart 10 to tilt as described.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A cart for transporting material, the cart comprising:
a frame; and
a plurality of wheels rotatably mounted to the frame in substantially parallel alignment and having lowermost points, a first pair of the wheels generally positioned at a first end of the cart, a second pair of the wheels positioned generally at a second end of the cart, and third and fourth pairs of the wheels being positioned generally intermediate the first and second pairs of the wheels, wherein the third pair of the wheels is positioned in relative close proximity to the fourth pair of the wheels, the lowermost points of the first and second pairs of the wheels are tangent to a first plane below the frame, and the lowermost points of the third and fourth pairs of wheels are spaced further below the frame than the first plane.

2. The cart of claim 1 wherein a first wheel of each respective pair is secured on a first side of the frame, and a second wheel of each respective pair is secured on a second side of the frame opposite the first side of the frame.

3. The cart of claim 1 wherein the wheels of the third and fourth pairs are larger than the wheels of the first and second pairs.

4. The cart of claim 1 wherein the cart is tiltable so that the first and second pairs of wheels are alternately contactable with an underlying ground surface.

5. The cart of claim 1 wherein the cart includes a tower structure extending upwardly from the frame, the tower structure including securement structure for receiving, supporting, or securing material therewith.

6. The cart of claim 1 wherein the tower structure is adapted for securing gas cylinders.

7. The cart of claim 1 wherein the third and fourth pairs of wheels are mounted lower on the frame than the first and second pairs of wheels.

8. A cart for transporting material, the cart comprising:
a frame including flange portions extending downwardly therefrom;
a plurality of wheels rotatably mounted to the flange portions in substantially parallel alignment and having lowermost points, a first pair of the wheels generally positioned at a first end of the cart, a second pair of the wheels positioned generally at a second end of the cart, and at least a third pair of the wheels being positioned generally intermediate the first and second pairs of the wheels, the lowermost points of the wheels of the third pair being lower than the lowermost points of the first and second pairs of the wheels, the flange portions extending over sides of the wheels to a position in close proximity to an underlying ground surface.

9. The cart of claim 8 wherein the third pair of wheels is mounted lower on the frame than the first and second pairs of wheels.

10. The cart of claim 8 wherein each wheel is mounted between a pair of flange portions.

11. The cart of claim 8 wherein first wheels of each respective pair of the wheels are secured on a first flange portion substantially in rolling alignment with each other, and second wheels of each respective pair of the wheels are secured on a second flange portion substantially in rolling alignment with each other.

12. The cart of claim 11 wherein the first wheels are mounted between the first flange portion and a third flange portion, and the second wheels are mounted between the second flange portion and a fourth flange portion.

13. The cart of claim 11 wherein the first wheels are mounted generally at one side of the frame, and the second wheels are mounted generally at a second side of the frame.

14. The cart of claim 8 further including a fourth pair of wheels positioned generally intermediate the first and second pairs of the wheels, wherein the fourth pair of the wheels is positioned in relative close proximity to the third pair of the wheels, and wherein the third and fourth pairs of wheels are mounted at approximately the same height on the flange portions.

15. A cart for transporting material, the cart comprising:
a frame; and
a plurality of wheels rotatably mounted to the frame in substantially parallel alignment a first pair of the wheels generally positioned at a first end of the cart, a second pair of the wheels positioned generally at a second end of the cart, and third and fourth pairs of the wheels being positioned generally intermediate the first and second pairs of the wheels, wherein the third pair of the wheels is positioned in relative close proximity to the fourth pair of the wheels, and the third and fourth pairs of wheels are tangent to a first plane and the first and second pairs are tangent to a second plane, the first plane spaced further below the frame than the second plane.

16. The cart of claim 15 wherein the third and fourth pairs of wheels are mounted lower on the frame than the first and second pairs of wheels.

17. The cart of claim 15 wherein a first wheel of each respective pair is secured on a first side of the frame, and a second wheel of each respective pair is secured on a second side of the frame opposite the first side of the frame.

18. The cart of claim 15 wherein the cart is tiltable so that the first and second pairs of wheels are alternately contactable with an underlying support surface.

19. The cart of claim 15 wherein the cart includes a tower structure extending upwardly from the frame, the tower structure including securement structure for receiving, supporting, or securing material therewith.

20. The cart of claim 15 wherein the tower structure is adapted for securing gas cylinders.
